(19) United States
(12) Patent Application Publication
(10) Pub. No.: US 2015/0121448 A1
(43) Pub. Date: Apr. 30, 2015

(54) MOBILE AND DESKTOP COMMON VIEW OBJECT

(71) Applicant: NetIQ Corporation, Houston, TX (US)

(72) Inventors: Lloyd Leon Burch, Payson, UT (US); Baha Masoud, Orem, UT (US); Thomas Crabb, Orem, UT (US)

(73) Assignee: NetIQ Corporation, Houston, TX (US)

(21) Appl. No.: 14/068,541

(22) Filed: Oct. 31, 2013

(51) Int. Cl. H04L 29/06

(52) U.S. Cl. CPC H04L 63/20
USPC 726/1

(57) ABSTRACT

In a computing system environment for viewing, accessing, and executing computing resources on one or more computing devices of a user, methods and apparatus include creating an object configured to provide at least one navigational aid for display on at least one of the computing devices. The object allows a user to view, navigate to, and access the computing resource. The object further includes one or more computing policies defining access rights for the computing resource and a listing of one or more other computing resources required for loading and/or executing the computing resource. Other computing resources necessary for loading and/or executing the computing resource are held separate from the object, thus providing information needed to execute the computing resource to the user while abstracting methods and resources required to build and use the computing resource.

### FIELD OF THE INVENTION

Generally, the present invention relates to accessing computing resources from mobile and desktop computing devices in a computing system environment. Particularly, it relates to creating application and function view objects representative of the computing resources, which allow viewing the resources across a variety of computing platforms, mobile and desktop. The objects separate logic relating to requirements for viewing, accessing, and executing the computing resources from logic relating to actual permissions, authentications, software, etc. required to access and execute the resources.

### BACKGROUND OF THE INVENTION

Enterprise use of mobile computing devices is widespread, to provide convenience and meet the needs of customers and enterprise employees alike. For example, a variety of enterprise products and services are provided or advertised via an enterprise Web site. Likewise, employees often access enterprise information and applications from a personal or enterprise-issued mobile computing device. Indeed, with modern technologies and availability of services online, enterprises must increasingly recognize the notion of “locational independence,” i.e. the concept that work is often an activity to be undertaken anywhere, rather than at a fixed physical location. As a corollary to these activities, enterprises require ways to keep their portals, such as browser-based portals, current.

These tasks of offering information and applications and of keeping the portal by which they are offered current are conventionally separate activities, requiring significant and repetitive development efforts, often from different development groups within the enterprise or separate from the enterprise. Such repeated and often poorly coordinated efforts consume valuable enterprise resources, and can often introduce errors and omissions.

Moreover, in the context of accessing enterprise resources such as via an enterprise portal, end users typically prefer a similar user experience. For example, in accessing company resources such as a general ledger with expected features such as accounts receivable, accounts payable, etc., the end user prefers a similar user experience and even “look and feel” of the resource when accessed from a desktop computing device, a mobile computing device, and indeed from different types of mobile computing platforms (tablet computing devices, smartphones, personal digital assistants or PDAs, and the like). The ability to provide company resources via a similar end user experience across a variety of computing platforms will in turn provide the benefit of allowing reduced training time for certain enterprise resources. That is, once the user is trained to use the resource on, for example, his or her office desktop computer, little to no additional training time is needed for the user to be “up to speed” on using the resource on a different computing device platform such as a personal or enterprise-issued tablet computer or smartphone.

However, as is known the end user experience for an application can vary depending on whether the application is accessed from a desktop or mobile computing device, and indeed depending on the mobile computing device platform used. For example, desktop and mobile computing devices vary greatly as to displayed content, accessibility, and functionality of a resource such as an enterprise browser-based portal. Mobile devices typically provide only the most crucial information, such as location-specific features and functions compared to a desktop device. Mobile devices typically allow less hypertext functionality compared to desktops, fewer graphics, more limited navigation options and features, etc. compared to desktops. On the other hand, mobile devices may offer certain functionalities less common on desktop computing devices, such as integration with telephone functions, location detection services and tailoring search results to particular locations, etc.

In turn, because of the differences between mobile and desktop computing devices, the requirements for accessing and executing a same resource may vary widely. That is, a mobile device may require an entirely different set of permissions, authentications, and software elements to execute a computing resource compared to a desktop computing device executing the same computing resource. These distinctions may become even more pronounced for a mobile computing device operating outside of enterprise security parameters, for example outside of an enterprise firewall. Still more, many enterprises have effected a “bring your own device” (BYOD) policy, allowing employee-owned devices to access one or more enterprise services, such as email, calendars, and contacts. Implementation of such BYOD programs and policies for employee-owned devices raise additional and often unique issues of security, information technology (IT) services, and application availability due to the wide variety of device types, operating systems, etc. which may have to be accommodated.

Accordingly, there are needs in the art for simple, yet effective ways of providing access to enterprise resources to users, providing a similar end user experience and view. The need extends to providing access to enterprise resources to users providing a similar end user experience, view, “look and feel” etc. across a variety of computing platforms including desktop and mobile computing devices. Naturally, any improvements should further contemplate good engineering practices, such as relative inexpensiveness, stability, ease of implementation, low complexity, security, etc.

### SUMMARY OF THE INVENTION

The above-mentioned and other problems become solved by applying the principles and teachings associated with the hereinafter described mobile and desktop common view object termed an Application and Function View (AFV) object. In one aspect, a method of viewing, accessing, and executing a computing resource in a computing system environment is provided which includes creating an object representing the computing resource. The object is configured to provide at least one navigational aid for display on at least one of the computing devices to allow a user to view the computing resource. The object further holds one or more computing policies defining access rights requirements for the computing resource. The object also holds a listing of one or more other computing resources required for loading and/or executing the computing resource. The other computing resources necessary for loading and/or executing the computing resource are separate from the object.

The described methods for viewing, accessing, and executing a computing resource available to one or more desktop and/or mobile computing devices includes providing a first component configured for creating an object representing the computing resource and defining one or more requirements for viewing, accessing, and executing the computing resource, and providing a second component configured for acquiring the object from the first computing resource and for displaying the object on at least one mobile computing device.

Appliances are provided for controlling viewing, accessing, and executing a computing resource available to one or more computing devices. The access appliances include an administrator interface configured for creating an object representing the computing resource and defining one or more requirements for viewing, accessing, and executing the computing resource. A proxy service for controlling access to other protected or unprotected computing resources is included. Finally, a service defining at least authentication and security requirements for the computing resource is included in the appliance.

As will be described in greater detail, a significant advantage of the above summarized methods and devices is separating logic and policies defining requirements for accessing and executing computing resources from logic, policies, and software for actually accessing and executing computing resources. By this separation, objects are defined which operate across any computing platform, regardless of specific platform needs and operational differences, but still allow a user to view and, if allowed, access and execute the resource from any platform, mobile or desktop.

These and other embodiments, aspects, advantages, and features of the present invention will be set forth in the description which follows, and in part will become apparent to those of ordinary skill in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a diagrammatic view in accordance with the present invention of a representative computing system environment for viewing, accessing, and executing computing resources;

FIG. 2 represents an appliance for providing a common mobile and desktop view for viewing, accessing, and executing computing resources; and

FIG. 3 depicts a representative enterprise portal showing a variety of application and function view objects representative of multiple computing applications.

### DETAILED DESCRIPTION OF THE ILLUSTRATED EMBODIMENTS

In the following detailed description of the illustrated embodiments, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process, mechanical, electrical, arrangement, software and/or other changes may be made without departing from the scope of the present invention. In accordance with the present invention, a mobile and desktop common view object for viewing and providing access to enterprise or other computing resources across a variety of computing platforms, yet delivering an experience that is consistent with the typical platform user experience, is hereinafter described.

At a high level, the AFV of the present disclosure separates business logic and implementation logic for an enterprise or other computing resource. That is, the AFV separates enterprise computing policy(s) for viewing, accessing, and executing computing resources from the actual elements needed for accessing/executing the computing resources, whereas in the prior art if an end user could view a resource, likely the user could access it and execute it. In other words, conventionally enterprise policy and procedure relating to rights to view an enterprise resource is the same as or is subsumed by the enterprise policy for actually accessing and using the resource. As an example, in prior art systems if an icon or other indicia allowing access to an enterprise resource can be legitimately viewed by an enterprise employee, the employee can typically access and execute the resource via the icon.

The AFV described herein holds and defines the requirements for an end user to view, access, and execute an enterprise resource, leaving it up to the particular computing platform being used to assemble, retrieve, and/or create the necessary elements for the user to actually access and execute the resource. That is, the AFV contains, in addition to definitions for one or more icons or other representations of one or more computing resources, one or more policies directed to user or user role requirements to display the icon, one or more execution paths for the resources, one or more resource requirements for execution, and other platform-specific elements for accessing/executing the resource. However, the AFV does not actually contain and assemble the needed elements to execute the resource or retrieve them, but instead simply provides a list of required elements.

The AFV accomplishes this by holding one or more computing policies defining the requirements for viewing and accessing/executing the computing resources. Without intending any limitation, these policies may be directed to the computing device being used, to a current location of the computing device being used (inside or outside a corporate firewall, for example), to a user identity, to a user role within an enterprise (employee, registered customer, and the like), and multiple other factors. The AFV can include additional policies, such as Access Control Language (ACL) required for configuring an enterprise gateway proxy, policies to control federated authentication sources such as identity providers, etc., policies to control adaptive authentication protocols, and other means for accessing protected enterprise or non-enterprise computing resources.

Advantageously, the policies are controlled for all views in a particular AFV so that adding the AFV to one user device can automatically make available a same view for a plurality of desktop and mobile computing device platforms of the user. By this feature, as an example an enterprise or other administrator can create a single AFV object, and all allowed desktop and mobile computing devices may be automatically updated to show and execute the AFV. Likewise, a mobile computing device user may add a created AFV object from a list or store of administrator-created AFVs to his or her desktop or mobile computing device, and all allowed desktop and mobile computing devices of the user may be updated to show and execute the AFV.

An enterprise administrator or other enterprise representative can create an icon that allows desktop and mobile computing devices to gain access to enterprise resources, such as internal enterprise resources, external resources, or others. The resources may be protected, such as by an enterprise gateway, by identity provider services, or other means, or may be unprotected. Access to enterprise internal resources protected by a gateway is contemplated, as is access to external resources such as software-as-a-service (SaaS) resources protected by authentication modules such as a Security Authentication Markup Language (SAML) Identity Provider (IDP).

Importantly, the AFV does not contain the actual policies for other computing resources which may be required to access and execute a particular computing resource, or retrieve such resources. Instead, the AFV only holds the elements required to access these elements. For example, the AFV does not contain policy for SAML-protected resources, proxy-protected resources, etc., only the information needed for access to the proxy which retrieves those resources. Likewise, the AFV does not contain software/instructions for creating a federation token, but rather only contains the description or definition of the needed authentication.

The view seen on a mobile computing device is provided by an application which displays and executes the created icon or other object to the user. The view on a desktop computing device is provided by a service or appliance which displays and executes the created icon or other object, and provides a similar desktop view as the mobile computing device view including one or more icons or other navigational aids representing each defined AFV and associated computing resource, thus providing as an example a dynamic HTML portal view which as will be seen takes into account policies directed to or implemented by the enterprise and directed to the end user of the desktop or mobile computing device. The desktop computing device version may be added to or replace an existing enterprise gateway portal.

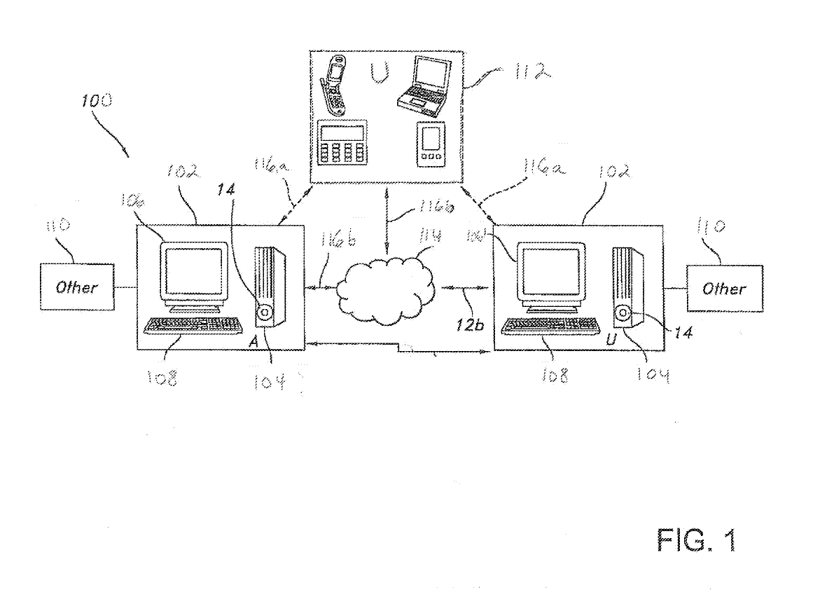

With reference to FIG. 1, a representative environment 100 for viewing, accessing, and executing one or more enterprise or other computing resources includes one or more computing devices 102 available per each of an administrator A and user U. In a traditional sense, an exemplary computing device includes a general or special purpose computing device in the form of a conventional fixed or mobile computer 104 having an attendant monitor 106 and user interface 108. The computer internally includes a processing unit for a resident operating system (suitable operating systems include those, such as DOS, WINDOWS, and MACINTOSH, to name a few), a memory, and a bus that couples various internal and external units, e.g., other 110, to one another. Representative computing devices include without limitation desktop computers, laptop computers, notebook computers, tablet computers, smartphones, and others. Representative other items 110 include, but are not limited to, PDA's, cameras, scanners, printers, microphones, joy sticks, game pads, satellite dishes, hand-held devices, consumer electronics, minicomputers, computer clusters, main frame computers or the like. In turn, standalone mobile computing devices 112 operate also in the environment 100.

In either, storage devices are contemplated and may be remote or local. While the line is not well defined, local storage generally has a relatively quick access time and is used to store frequently accessed data, while remote storage has a much longer access time and is used to store data that is accessed less frequently. The capacity of remote storage is also typically an order of magnitude larger than the capacity of local storage. Regardless, storage is representatively provided for aspects of the invention contemplative of computer executable instructions, e.g., software, as part of computer readable media. Computer executable instructions may also reside in hardware, firmware or combinations in any or all of the depicted devices 102 or 112.

When described in the context of computer readable media, it is denoted that items thereof, such as modules, routines, programs, objects, components, data structures, etc., perform particular tasks or implement particular abstract data types within various structures of the computing system which cause a certain function or group of functions. In form, the computer readable media can be any available media, such as RAM, ROM, EEPROM, CD-ROM, DVD, or other optical disk storage devices, magnetic disk storage devices, floppy disks, or any other medium which can be used to store the desired executable instructions or data fields and which can be assessed in the environment. It is further contemplated that certain of the computer readable media may not reside on the computing devices 102, 112, but may instead reside in the so-called “cloud,” represented nebulously as element 114, and be accessed as needed.

In network, the computing devices communicate with one another via wired, wireless or combined connections 116 that are either direct 116a or indirect 116b. If direct, they typify connections within physical or network proximity (e.g., intranet). If indirect, they typify connections such as those found with the internet, satellites, radio transmissions, or the like. In this regard, other contemplated items include servers, routers, peer devices, modems, T1 lines, satellites, microwave relays or the like. The connections may also be local area networks (LAN) and/or wide area networks (WAN) that are presented by way of example and not limitation.

Within the operational context of the described environment 100, a first element of the AFV described in the present disclosure defines an object providing a navigational aid associated with a computing resource, allowing a user to view, navigate to, and access a resource. While reference to a pictogram navigational aid such as an icon is frequently made in the present disclosure, the skilled artisan will appreciate that any suitable already known or future-developed navigational aid is contemplated, such as other types of pictograms, hypertext links, text descriptions, bookmarks, drop-down menu items, buttons, etc.

A second element of the AFV defines how and/or what other computing resources are required to load and/or execute the computing resource associated with the icon, i.e. provides instructions without actually holding or retrieving the specific elements (software, permissions, authentications, authentication tokens, etc.) needed to so execute or load the resource. This second element can be as simple as a single uniform resource locator (URL) or authentication requirement or as complex as an iOS or Android native application resource description, or may involve some other computing platform resource description.

A third element of the AFV defines any user role, user right, or user group membership, etc. required to display the AFV icon to an end user, i.e. for the user to actually be able to view the icon on a mobile or desktop computing device. For example, a user may be required to be an employee or registered customer of an enterprise in order for the AFV icon to be displayed on the user's mobile computing device. Still more, the user may be required to be a member of a particular employee or customer group, for example an engineer, upper management, etc., in order to view certain icons representative of restricted or sensitive enterprise computing resources. Alternatively, any employee or customer may be able to view an icon representative of a resource, but only members of a particular employee group may be able to use the icon to access/execute the resource.

A fourth element of the AFV defines resource dependencies needed to actually execute the resource. Exemplary dependencies can include one or more of a list of URL's, a list of employee or other end user roles, federation tokens, or other items needed to access and execute the resource. For example, implementation of user authentication is contemplated, such as simple user/password credentials, software tokens, hardware tokens, biometrics and other methods, and the AFV holds descriptions of those elements. Likewise, lists of elements required to implement adaptive authentication protocols are contemplated for inclusion in the AFV, including without limitation device type, device location, IP address, etc.

Implementation of a proxy service is contemplated also to allow access control for other required computing resources that do not support federated protocols. Advantageously, by use of a proxy any HTTP resource may be allowed to access an enterprise resource within the security and access control features of the AFV as summarized herein. An IDP may also be included to build access tokens and/or authentication tokens for use at an enterprise Policy Enforcement Point (PEP) and for external authentication. As an example, an access token produced by an IDP may be used by the proxy to authenticate a user and so control access to enterprise resources. The IDP may also be used by the AFV to automatically build authentication credentials for the enterprise resource, including federated tokens such as SAML or other authentication methods. It is contemplated to provide viewing and access to non-enterprise computing resources and “cloud” computing resources by this method, for example, SaaS resources, non-enterprise content providers (news services, online magazine services, etc.).

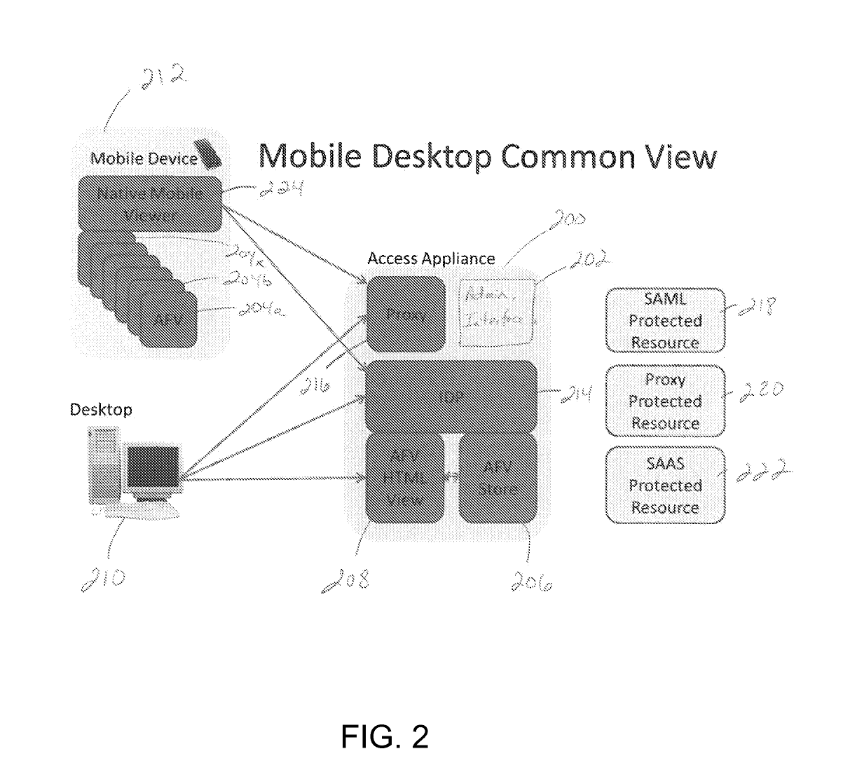

In more detail and with reference to FIG. 2, a first component of the invention is an access appliance 200 including an administrator interface 202 whereby an administrator or other enterprise representative can define one or more AFV objects 204a, 204b, etc. An AFV store 206 is included, for storing created AFV objects 204a, . . . 204x.

An HTML engine 208 is provided to present the created resource view to a browser (not shown) operating on a desktop computing device 210. The HTML engine 208 creates html pages viewable on the browser from the created AFV objects. Further, the HTML engine 208 can access AFV objects from the AFV store 206 for providing to the desktop computing device 210 browser.

A web service provides an interface between a mobile computing device 212 and AFV objects stored in AFV store 206. An identity service 214 may be included to authenticate users, created federation tokens and other authentication protocols, etc.

A proxy service 216 may be included to define access control to other computing resources, including enterprise and non-enterprise protected computing resources. As non-limiting examples, the proxy service 216 may control access to protected enterprise or non-enterprise computing resources, such as SAML protected resources 218, proxy protected resources 220, and SaaS-protected resources 222.

A second component of the invention is an application for inclusion on a mobile computing device 212. A native mobile viewer (NMV) application 224 is provided which renders a view of one or more AFV objects 204a, . . . 204x to an end user (not shown). The NMV 224 also provides an interface allowing the end user to add and organize AFV objects 204a, . . . 204x from the AFV store 206, runs applications on the mobile computing device 212 such as browsers and other native applications, and provides authentication credentials to the access appliance 200 as proof of end user identity.

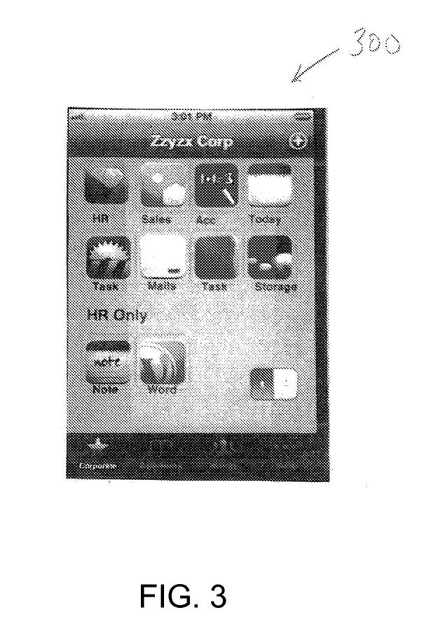

By the NMV 224, a user is provided a web or enterprise gateway portal 300 or “landing page” (see FIG. 3) providing a view of one or more AFV objects representing one or more computing resources or resource groups, for example a general ledger application (Acc) including accounts receivable and accounts payable, etc., a sales application (Sales) including sales data, forecasts, etc., a human resources (HR) computing resource providing access to employee data, and the like. For these AFV objects to appear on a user's mobile computing device, it may only be necessary for the user to be an employee of the enterprise, and to be able to provide necessary credentials as proof of the user's identity as an employee. On the other hand, for the user to access and/or execute a more privileged computing resource such as the HR computing resource or the general ledger resource, additional steps, authentications, other computing resources, etc. will be required. The AFV object associated with the computing resource, by the methods and devices set forth above, provides the business logic needed to implement these additional steps, authentications, other computing resources, etc., i.e. holds the information needed to determine what authorizations, credentials, tokens, other software, etc. are needed to access the computing resource from the user's platform.

It is then up to the user's computing platform to determine how to provide the specific items need to access and execute the resource. For example, the resource may be a cloud based resource such as a SaaS resource requiring federated authentication protocols (SAML), proxy access control for resources that do not support federated protocols, etc. The AFV supplies the list of elements needed to access and execute the resource according to the user's request and permissions, and software associated with the computing platform assembles or retrieves those needed elements (specific to the platform requirements) allowing resource execution.

As a result, certain advantages of the invention over the prior art are readily apparent to the skilled artisan. A single object (the AFV) holds logic defining what elements and/or information are required for access to enterprise and other resources, internal and external to the enterprise, such as resource location, authentication requirements, user role/identity/group membership requirements, etc., but not the actual logic, policies, etc. for the elements themselves. The single AFV likewise defines a single, familiar navigational aid for viewing and accessing the resource to end users on a plurality of desktop and mobile computing platforms, such as an icon.

However, the AFV is not required to hold or access the logic/software needed for actual access and execution of the computing resource. That is left up to the individual computing platform being used, and the logic/software required by particular desktop or mobile computing platforms to access and execute the computing resource may vary according to the specific platform. Therefore the AFV is essentially platform-independent.

As another advantage, by this feature both the end user and the enterprise or other administrator are shielded from any requirement for knowledge of or accessing different methods/software applications, etc. for executing the resource in accordance with different requirements imposed by the type of computing platform being used. The end user need only click the AFV-created icon, and in accordance with the particular computing platform being used, if entitled to the resource will be presented with the requirements to be satisfied to access and execute the resource but will not be tasked with selecting or retrieving specific platform-dependent elements. The platform itself will select, retrieve, assemble, etc. those requirements according to the “blueprint” provided by the AFV.

Still more, by use of the AFV of the present disclosure, a mobile computing device can alter a desktop computing device view for a resource or group of resources, and vice versa. That is, a properly authenticated/authorized user can, by use of the AFV, add to or remove from his or her desktop or mobile computing device an icon representing a resource, and the corresponding view for other computing devices of the user will be correspondingly altered to reflect the newly added or removed resource.

Finally, one of ordinary skill in the art will recognize that additional embodiments are also possible without departing from the teachings of the present invention. This detailed description, and particularly the specific details of the exemplary embodiments disclosed herein, is given primarily for clarity of understanding, and no unnecessary limitations are to be implied, for modifications will become obvious to those skilled in the art upon reading this disclosure and may be made without departing from the spirit or scope of the invention. Relatively apparent modifications, of course, include combining the various features of one or more figures with the features of one or more of other figures.

1. In a computing system environment having pluralities of computing devices, a method of viewing, accessing, and executing a computing resource available to one or more of the computing devices, comprising:
creating an object representing the computing resource and configured for display on at least one of the computing devices;
provisioning the object with one or more computing policies defining access rights for the computing resource; and
provisioning the object with a listing of one or more other computing resources required for loading and/or executing the computing resource;
wherein the one or more other computing resources necessary for loading and/or executing the computing resource are separate from the object.

2. The method of claim 1, wherein the object is created by an enterprise administrator according to enterprise computing policy.

3. The method of claim 1, wherein the listing of one or more other computing resources includes a listing of other computing resource policies to execute the computing resource, including one or more of authentication, security and access control requirements for the computing resource according to the at least one of the computing devices.

4. The method of claim 3, wherein the computing resource policies include policies directed to one or more of user authentication information, computing device authentication information, and access control language for the other computing resources.

5. In a computing system environment having pluralities of computing devices, a method for viewing, accessing, and executing a computing resource available to one or more of the computing devices, comprising:
providing a first component configured for creating an object representing the computing resource and defining one or more policies for viewing, accessing, and executing the computing resource; and
providing a second component configured for acquiring the object from the first computing resource and for displaying the object on at least one mobile computing device.

6. The method of claim 5, further including providing a first component comprising at least a proxy service defining computing policies for controlling access to other computing resources and a service defining at least authentication and security policies for the computing resource.

7. The method of claim 6, further including providing a first component including an engine configured to provision the object to one or more computing device browser applications.

8. The method of claim 6, further including providing a first component including at least one service configured to provision a mobile computing device interface to the object.

9. The method of claim 6, including providing a first component including an identity provider module configured to define at least authentication and security policies for the computing resource.

10. The method of claim 5, further including providing a first component including an administrator interface configured for creating the object.

11. The method of claim 5, further including providing a first component including an object store configured for storing one or more created objects.

12. The method of claim 8, including providing a second component for provisioning to at least one mobile computing device, the second component including a mobile computing device viewer configured for viewing the object on the mobile computing device.

13. The method of claim 12, including providing a mobile computing device viewer configured to interface with the first component at least one service for providing a mobile computing device interface to the object.

14. The method of claim 12, including providing a mobile computing device viewer configured to provision authentication credentials for the mobile computing device and/or a user of the mobile computing device to the first component.

15. The method of claim 6, including providing a proxy service configured with policies to control access to other computing resources including enterprise internal computing resources protected by a gateway or external computing resources protected by an authentication or credentialing service.

16. The method of claim 15, wherein the at least one authentication credentialing service is a Security Authentication Markup Language (SAML) service.

17. An access appliance for controlling viewing, accessing, and executing a computing resource available to one or more of the computing devices, comprising:
an administrator interface configured for creating an object representing the computing resource and defining one or more policies for viewing, accessing, and executing the computing resource;
a proxy service defining one or more policies for controlling access to other protected or unprotected computing resources; and
a service defining at least authentication and security policies for the computing resource.

18. The access appliance of claim 17, further including an engine configured to provision the object to one or more computing device browser applications.

19. The access appliance of claim 17, including an identity provider service defining at least authentication and security requirements for the computing resource.

20. The access appliance of claim 17, including a proxy service configured with one or more policies for controlling access to at least one of Security Authentication Markup Language (SAML) protected computing resources, proxy protected computing resources, and software-as-a-service (SaaS) computing resources.

21. The access appliance of claim 6, further including an object store configured for storing one or more created objects.
